(19) United States
(12) Patent Application Publication
(10) Pub. No.: US 2018/0174186 A1
(43) Pub. Date: Jun. 21, 2018

(54) SOCIAL BUSINESS NETWORK SYSTEM AND METHOD

(71) Applicants: James Tax, Phoenix, AZ (US); Stephen P. Cardinal, Carefree, AZ (US); Thomas Curran, Cave Creek, AZ (US)

(72) Inventors: James Tax, Phoenix, AZ (US); Stephen P. Cardinal, Carefree, AZ (US); Thomas Curran, Cave Creek, AZ (US)

(21) Appl. No.: 15/793,925

(22) Filed: Oct. 25, 2017

Related U.S. Application Data
(60) Provisional application No. 62/412,727, filed on Oct. 25, 2016.

(51) Int. Cl. G06Q 30/02; G06Q 50/00

(52) U.S. Cl. CPC G06Q 30/0255; G06Q 50/01; G06Q 30/0201; G06Q 30/0272

(57) ABSTRACT

Systems and methods are provided that create, establish, and maintain a social business network that cuts out the middle men and provides that value back to consumers. Consumers will receive dollars or other value directly back for engaging with brands or businesses by watching ads, shopping, completing surveys, etc.

### PRIORITY

The application claims priority to and the benefit of U.S. Provisional Patent Application No. 62/412,727, filed Oct. 25, 2016, which is fully incorporated herein by reference.

### TECHNICAL FIELD

The present invention relates generally to systems, methods, and computer programs for linking businesses and consumers together for mutual benefit.

### BACKGROUND OF THE INVENTION

Businesses spend billions of dollars attempting to leverage “Big Data” to identify consumers before they make purchase decisions. Advertisers leverage programs such as email marketing, targeted digital display/video, search & retargeting, and lead aggregator purchases to generate sales. It is estimated that United States digital ad spending will total $68B in 2016, and worldwide digital ad spending will be $186B. The United States market alone may grow to $105B by 2020. Digital ad spending may increase from 26.8% of total media spending to over 39% of total media spending worldwide by 2019.

Consequently, consumers are inundated with emails, pop-ups, pre-roll content, display advertising, and other messages from advertisers when they may not be interested. Further, these attempts at consumer outreach and advertising can often be irrelevant to the consumer's purchasing needs or desires. As consumer consumption of digital content continues to increase, ads in mobile apps, webpages, and pre-roll videos frustrate consumers and undesirably take up valuable time. This, in turn, can drive consumers away from valuable and relevant advertising.

On the business side, advertisers have various choices as to where to place their advertising dollars. The largest beneficiaries of the trend to spend more in digital advertising is generally Google™, YouTube™, and Facebook™. However, only YouTube™ will pass on a percentage of advertising revenue to some of its users.

Accordingly, there exists a need for new, improved, and more efficient systems and methods for linking business and consumers together to provide more valuable and targeted advertising, couponing, and the like, to provide reciprocal benefit to both consumers and businesses.

### SUMMARY OF THE INVENTION

Particular embodiments of the present invention are directed to systems and methods to create, establish, and maintain a social business network that cuts out the middle men and provides that value back to consumers. Consumers get a portion of the proceeds for providing their correct information, intentions, and their time, to the system and to businesses.

The present invention will engage consumers directly to participate in the investment in increased digital advertising and the value of their data. Consumers will receive dollars or value directly back for engaging with brands through watching ads, shopping, and completing surveys.

The system will link businesses and consumers together for mutual benefit. Various proprietary algorithms of the system will help businesses be more efficient in ad targeting and couponing, and consumers benefit from that efficiency as well.

The above and other aspects and embodiments of the present invention are described below with reference to the accompanying drawings.

### BRIEF DESCRIPTION OF THE DRAWINGS

The accompanying drawings, which are incorporated herein and form part of the specification, illustrate various embodiments of the present disclosure and, together with the description, further explain the principles of the disclosure and to enable a person skilled in the pertinent art to make and use the embodiments disclosed herein. In the drawings, like reference numbers indicate identical or functionally similar elements.

FIG. 1 shows a conventional consumer data ecosystem.

FIG. 2 shows exemplary institutions and the conventional allocation of value to determine the monetary value of the consumer.

FIG. 3 shows a social business network solution that provides value to consumers and businesses, in accordance with embodiments of the present invention.

FIG. 3a shows an exemplary hardware and system architecture, in accordance with embodiments of the present invention.

FIGS. 3b-3c show exemplary interactions, steps, and processes for a social business network and system including consumers, businesses, and third-party services, in accordance with embodiments of the present invention.

FIG. 4 shows the value to businesses of a social business network solution, in accordance with embodiments of the present invention.

FIG. 5 shows the value to consumers of a social business network solution, in accordance with embodiments of the present invention.

FIG. 6 shows exemplary consumer engagement levels for a social business network solution, in accordance with embodiments of the present invention.

FIG. 7 shows exemplary monetization life cycles for a social business network solution in accordance with embodiments of the present invention.

### DETAILED DESCRIPTION

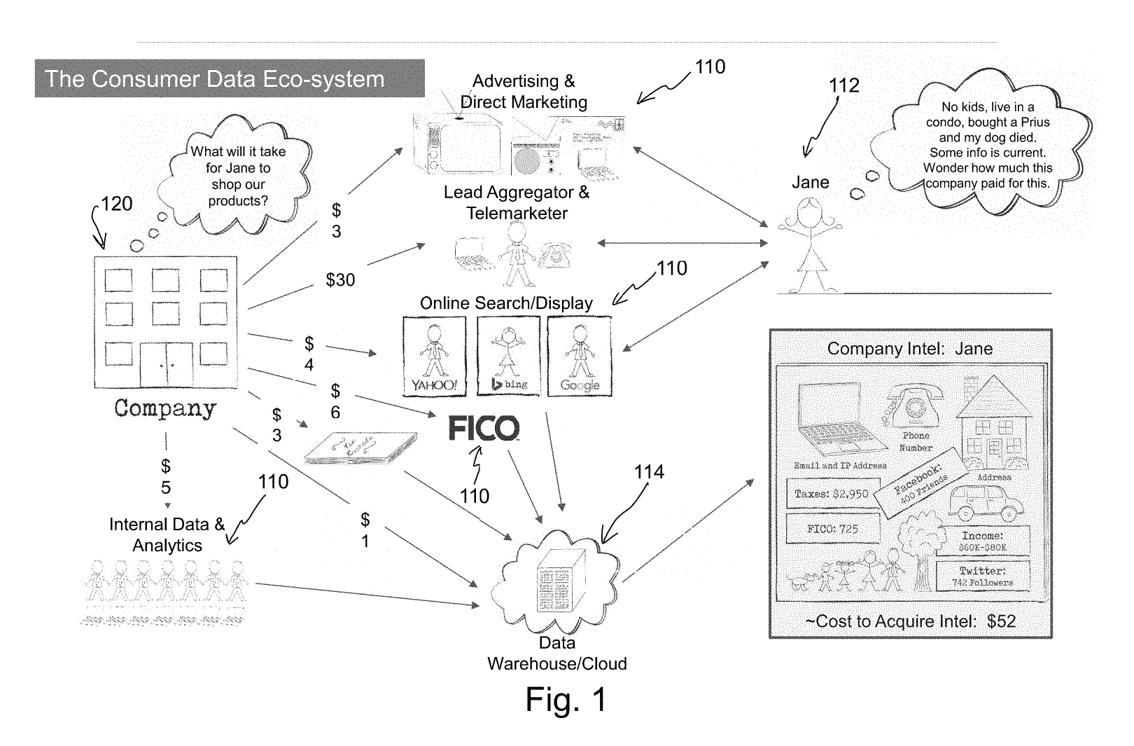

Referring generally to FIGS. 1-7, exemplary methods, and computer programs, or software application systems 100 are adapted and configured to link business and consumers together for mutual benefit. Consumers can engage with the system 100 through a website, app, or routine emails about offerings from companies willing to pay for them to shop. Other forms of engagement and communication can be employed as well without deviating from the spirit and scope of the present invention.

Businesses can develop relationships through the system 100 and business relationship specialists. Consumers will complete a profile with inputted information about their background, and current and future shopping needs. The inputted data can include full name, email address, payment receipt method, preferred companies or company types (e.g., banks, mortgage companies, insurance companies, retail companies, etc.), home owner or renting status, occupation, income, credit score or worthiness, financing needs or interests, military status, profession, desire to be contacted by businesses, brand preferences, product preferences, and a myriad of base information or data. The system 100 and corresponding processes can add external data to the consumer profile as well. Businesses can pay into or subscribe to the system to engage with consumers when they are likely to need products, or to build brand awareness. Consumers receive cash, discounts, or coupons based upon the value of the lead. Consumers can selectively opt-in to the programs and receive value for becoming a “lead.” Both consumers and businesses have the ability to rate the experience with each other.

The system 100 will engage consumers directly to participate in the investment in increased digital advertising. Consumers will be given dollars or value directly back for engaging with brands through watching ads, shopping, completing surveys, etc.

Consumers can choose the interaction level with the system and access to businesses. Consumers will be encouraged to give “legitimate consideration” to the offerings and will earn higher points based upon their receptiveness to, and the level of engagement with, the system 100 (e.g., click on ad, go to website, complete information forms, etc.). Businesses will be encouraged to provide value by offering discounts, coupons, and premier pricing structures. Consumers will earn a portion of every advertising and lead dollar received by the system.

Embodiments of the present invention will further engage with consumers by creating a social multi-level network marketing system funded by consumers' willingness to engage brands directly. This program will allow actively engaged consumers to recruit to develop a network of other system consumers. The multi-level network will allow consumers to generate additional cash and benefits depending upon how broad and active their corresponding network becomes. This will provide a multi-level network marketing program that will not require participants to purchase products, training, etc. Users will be able to participate and the increasing dollars brands are willing to pay to engage directly with consumers.

The direct sales model (network marketing, multi-level marketing, etc.) of the system 100 will not require consumers to pay for products or technology. Instead, consumers can earn income as a percentage of the value of their data, shopping behavior, or other relevant programs.

The system 100 of the present invention presents a ubiquitous social network, providing meaningful income to consumers and the network with the highest return on investment for the advertising partners.

By creating a transparent network of users that understand the value of their purchasing decisions, consumers will benefit from receiving cash, discounts, and coupons in return for providing information about themselves and future purchasing needs. Businesses will benefit from higher engagement with consumers, and from providing consumers with resources that would otherwise be spent on lead development and marketing. Consumers will have the ability to generate income without investing money through a network marketing approach to benefit from the breadth and depth of their network. Once the network is established, it will be possible to expand beyond the lead management into other forms of digital advertising revenue sources, such as: banner advertising, retargeted advertising, mobile in-game advertising, mobile game credits, survey and research investments, search advertising, and the like.

Embodiments of the present invention can process and create a network score, which is akin to a credit score for data. The system 100 algorithms process data from information provided from consumers, and supplied from other sources, to develop the score. The higher the score, the more value for brands to connect, and consumers to receive targeted, relevant, and efficient advertising. The algorithms will generate scores by industry, by consumer, and will be transparent—with tips on how to increase the score displayed for the user. The algorithm processes and scores data, and presents a value on data for exchange (e.g., currency).

The system 100 permits users to scan apps on mobile or other devices to generate or otherwise modify their corresponding “score.” Further, geolocation systems and software can be implemented with the system 100 to develop and efficiently fine tune the user's profile (e.g., determine where the user goes to determine the type of consumer, and the most relevant or applicable goods and services for a user).

FIG. 1 illustrates the current state of the consumer data ecosystem. An onslaught of potentially relevant data (e.g., analytics, online search information, direct marketing, FICO data, etc.) 110 on a consumer (e.g., Jane) 112 is communicated or transferred to one or more data warehouses or cloud collections 114 for use by a company—with exemplary costs paid by companies for this data, or data types. The data is used in an attempt to target advertising at the consumer. However, the received data can be incorrect, unfiltered, outdated, and may provide minimal reliable information on the user's current needs for goods or services. Companies are left to process and extrapolate needs and tendencies from this data which, again, can be insufficient or erroneous. More importantly, the received data doesn't permit input directly from the most relevant source available: the consumer.

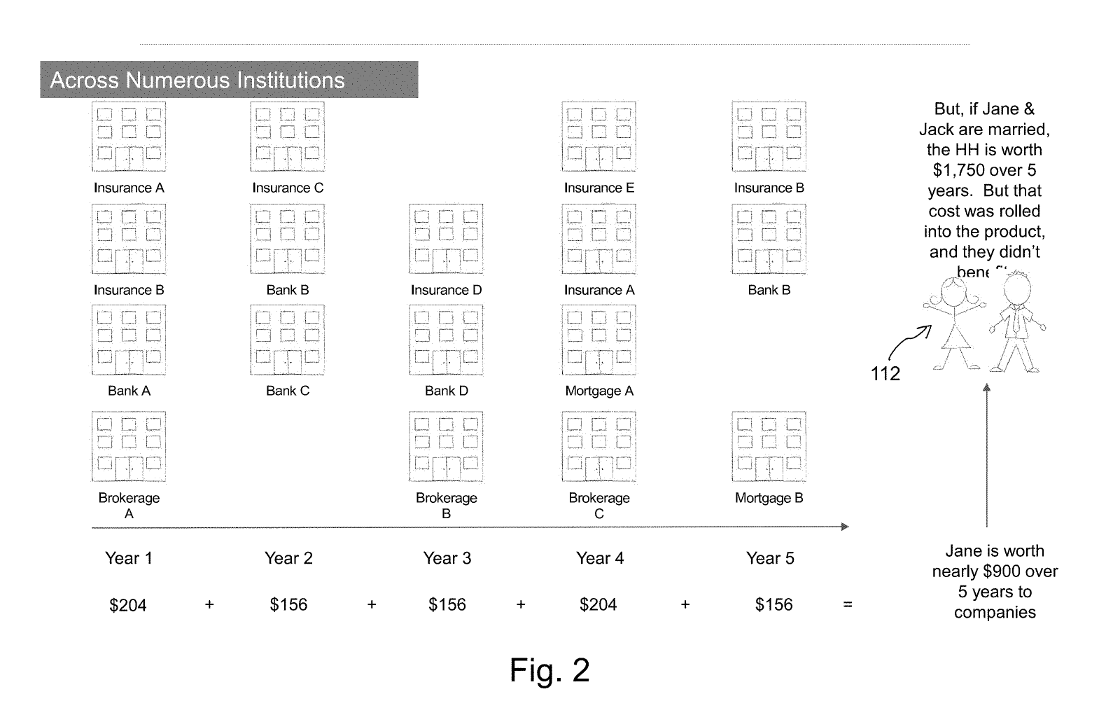

FIG. 2 shows exemplary institutions and the conventional allocation of value to determine the monetary value of the consumer 112 across a five-year period.

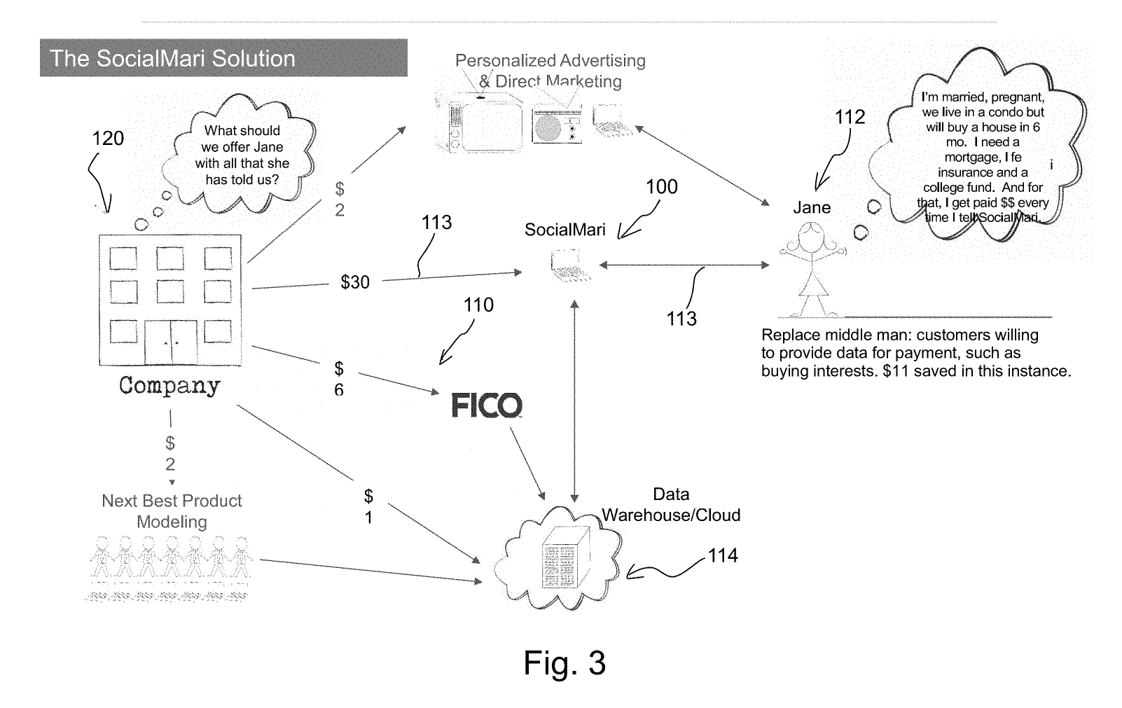

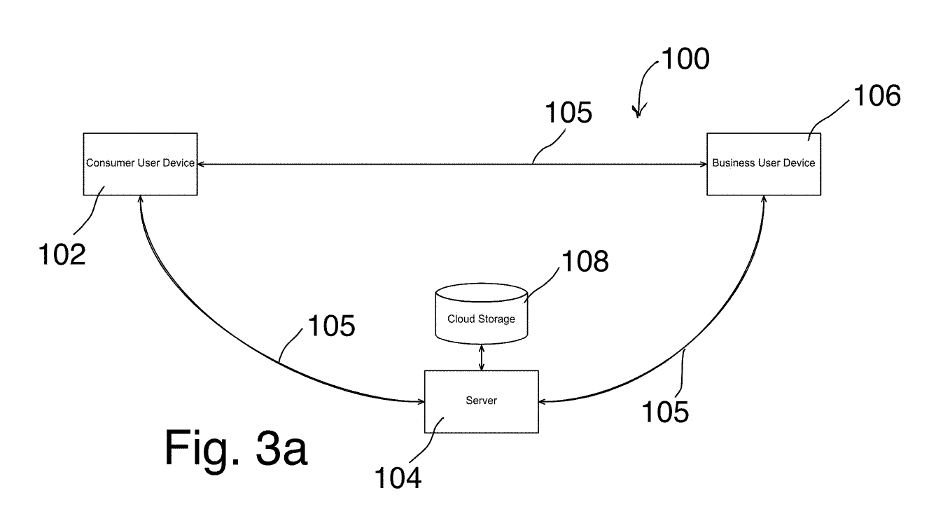

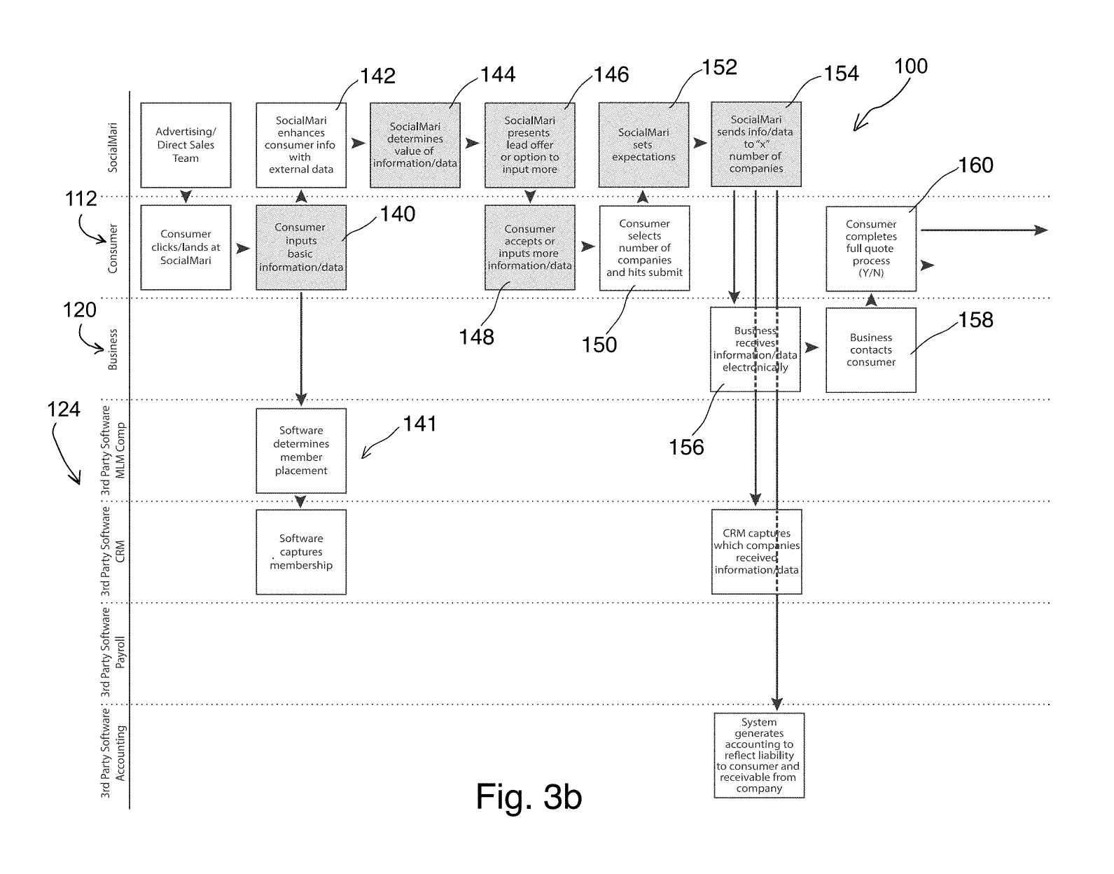

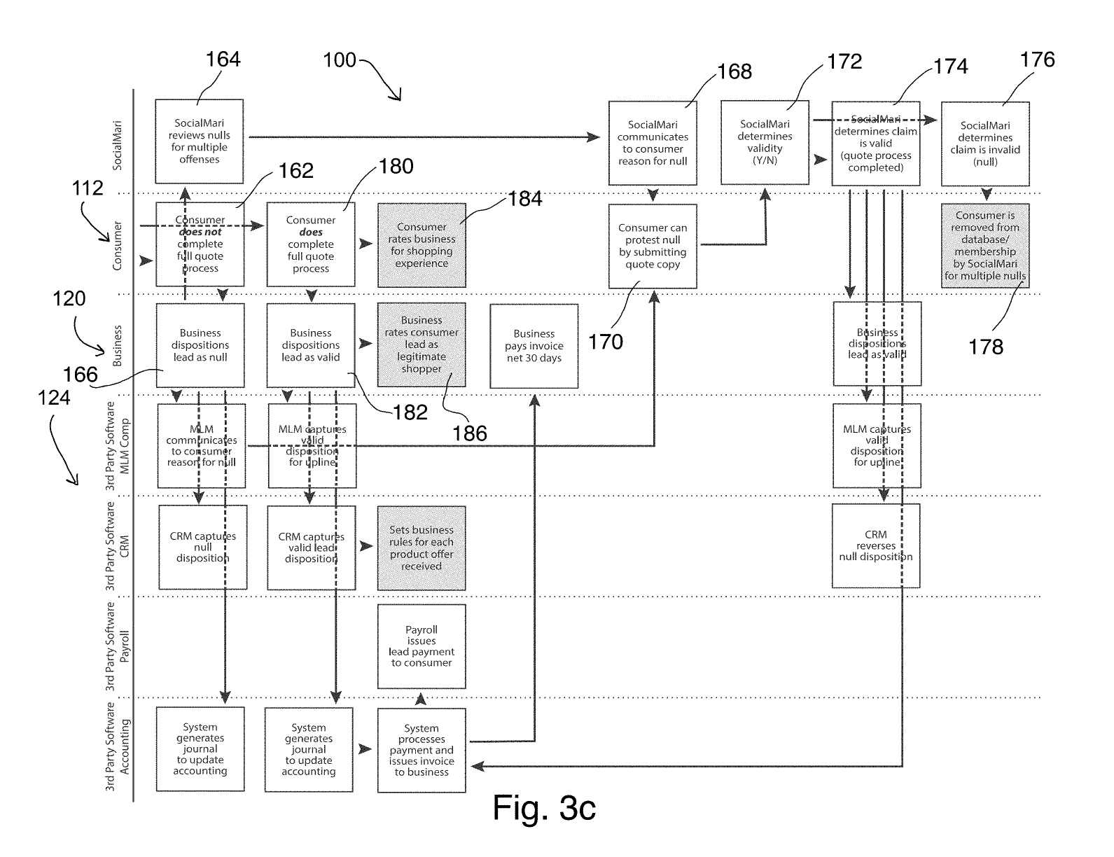

FIGS. 3-3b illustrate implementation of the present invention to provide interaction and processing steps between the system 100, consumer users 112, business users 120, and third-party services/systems users 124. The system 100 can process relevant data directly from and between the consumer 112 and businesses 120 across one or more networks 105 (e.g., the Internet). The system 100 can further communicate with other systems and services, such as data warehouses and cloud collections 114, to obtain and process additional relevant data on consumers 112. The system 100 network provides a myriad of potential customers willing to provide highly relevant data in exchange for payment or other compensation. As a result, the system 100 allows customers to tell companies, via the system 100, what they are interested in purchasing before they actually purchase anything. This elimination of the “middle man” in financial services allows the system 100 to give value back to both participating consumers and businesses. In turn, a cost savings is passed on to companies, while simultaneously providing much more reliable and relevant purchasing data on customers compared to conventional data collection and advertising methods.

FIG. 3a shows a system or hardware configuration for embodiments of the present invention. Namely, the system 100 can include one or more consumer user devices 102, one or more system servers 104, and one or more business user devices 106. The computing devices or systems 102, 104, 106, can be operatively connected and in communication via a network 105, such as the Internet, and at least the one or more servers 104 can be connected to a data storage device or system 108. The data storage 108 can be a secure cloud storage service/system and/or an on-site storage connected directly to the one or more servers 104.

FIGS. 3b-3c shows exemplary system steps, including initial interactions and data input/processing to and from the consumer, processing and interactions between businesses, consumers, and third-party software and services, and consumer payments (or nulls) processes. The term “SocialMari,” or like wording, is used in various parts of the figures to reference the system 100, or portions thereof.

FIG. 3b provides exemplary steps for establishing membership and lead value for consumers using the system 100. The consumer arrives at the system 100 website or server 104, via the consumer user device 102, and inputs basic information pertaining to the user at step 140. The inputted data can include the user's full name, email address, payment receipt method, preferred companies or company types (e.g., banks, mortgage companies, insurance companies, retail companies, etc.), home owner or renting status, occupation, income, credit score or worthiness, financing needs or interests, military status, profession, desire to be contacted by businesses, brand preferences, product preferences, and a myriad of base information or data. The system 100 determines member placement and captures or stores the membership (step 141). The system 100 can enhance or augment the consumer data with external or additional data, at step 142. At step 144, the system 100 processes the information/data and algorithmically determines a value for the information inputted based on prior lead values from various company purchases.

At step 146, the system 100 presents or displays the lead value to the consumer, or permits an opportunity for the consumer to input additional information to potentially achieve a higher lead value amount—based on what the applicable companies have previously paid for information. At step 148, the consumer accepts the lead value, or inputs additional information or data. Then, at step 150, the consumer user is permitted to select how many companies can contact them through the system 100. Next, the system 100 processes the information, sets, and stores expectations based on stored and processed business rules of the system 100 (step 152). This can include the length of calls to expect, what the consumer needs to do to receive payment for quotes, etc. This is much different than traditional lead aggregators that simply send consumer information to numerous sources without any context for the consumer.

At step 154, the system 100 delivers or sends the customer information (email, SMS text, within the website, etc.) to one or more companies, and only to the number of companies that the consumer user selected. The participating businesses or companies receive the consumer user's information and data, e.g., electronically (step 156). The cloud operation, interface, and storage of the system 100 enables any participating company or business to download lead data into their unique systems. Compatibility and integration is made universal and easy. At steps 158 and 160, the business contacts the consumer (e.g., electronically, by phone, etc.) and the consumer is able to complete/consume the advertising or quote process, respectively.

At step 162, as shown in FIG. 3c, there are times when the consumer user does not complete the full quote or advertisement process. The system 100 processes and reviews nulls for multiple offenses of non-completion (step 164). The system 100, therefore, quality assurance is obtained and it can be determined whether users are trying to abuse the system or are simply “window shopping” in an attempt to earn money. For instance, a user with two null responses can be removed from the platform, in certain embodiments. In addition, the business user or business system disposition the consumer lead as null (step 166). At step 168, the system 100 communicates (e.g., electronically) to the consumer user a reason for the null flag. The consumer user can protest the null by submitting, to the server, a copy of the quote or other indicator of completion (step 170). At step 172, the system 100 processes the challenge and determines its validity. If it is a valid challenge, the system 100 determiens the claim is valid (step 174) and the business or third-parties will similarly disposition the lead as valid. If the system 100 determines the claim is invalid, at step 176 and 178, the consumer user can be removed from the system database and their membership can be revoked—for multiple nulls. Unlike traditional lead aggregators, the system 100 manages the customers and attempts to maximize revenue from financial institutions.

If the consumer did complete the full quote process (step 180), the business user dispositions the lead as valid (step 182) and rates the consumer user lead as a legitimate shopper or participant (step 186). This review can be used by the system 100 to establish pricing of leads for companies. For instance, a 5-star rated lead can encompass those users truly interested in the products, that watched or listened to the entire pitch, and potentially purchased products at a premium. The consumer user can also rate the business based on the shopping experience or other factors, at step 184. As such, the system 100 provides a unique service for providing review of a company's salespeople, competitiveness with regard to quotes, and the like. This, in turn, creates increased transparency for consumer on what to expect from each of the participating companies or businesses.

Companies do not want to buy perpetual shoppers, and often cannot compete on price when a consumer jumps from one company to another with frequency. As such, the system 100 can lock customers out of offers after they have used them for a certain period of time (e.g., insurance=12 months, refinance=24 months, credit cards=6 months, etc.) to ensure companies are receiving the best, or viable, shopping users. The system 100 further offers a revenue share for lead aggregator services. For instance, consumer users can be paid up to 50% of the lead revenue that is received from financial institutions.

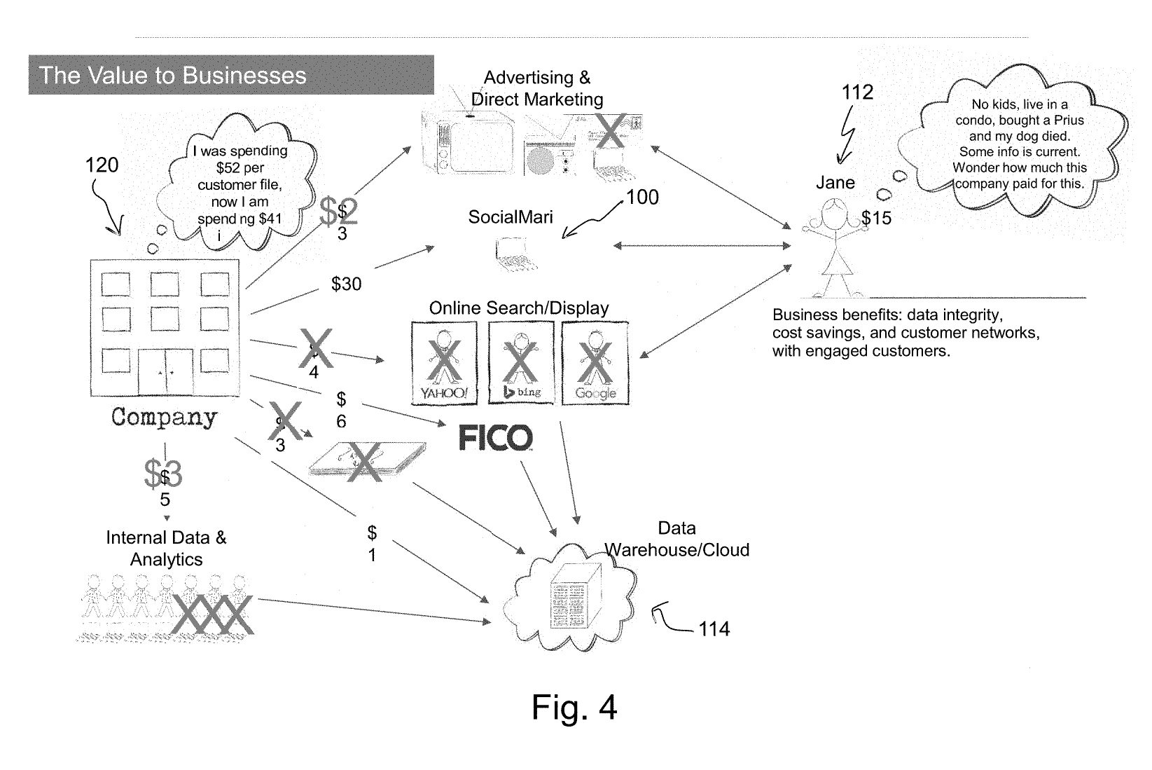

As illustrated in FIG. 4, the system 100 of the present invention assists businesses on at least three different fronts: data integrity, costs savings, and customer networks. Because the system 100 receives data about desired products/services directly from the consumer user, the data is highly relevant and current. With regard to costs, the expense of data and analytics is reduced, and search marketing and traditional direct marketing is rendered obsolete.

The consumer user is engaged because they are receiving direct value—e.g., monetary, as well as targeted and useful advertising based on their personal data. Moreover, the consumer can become increasingly engaged with the system 100 and may refer friends, family, etc. This can further generate value for the consumer.

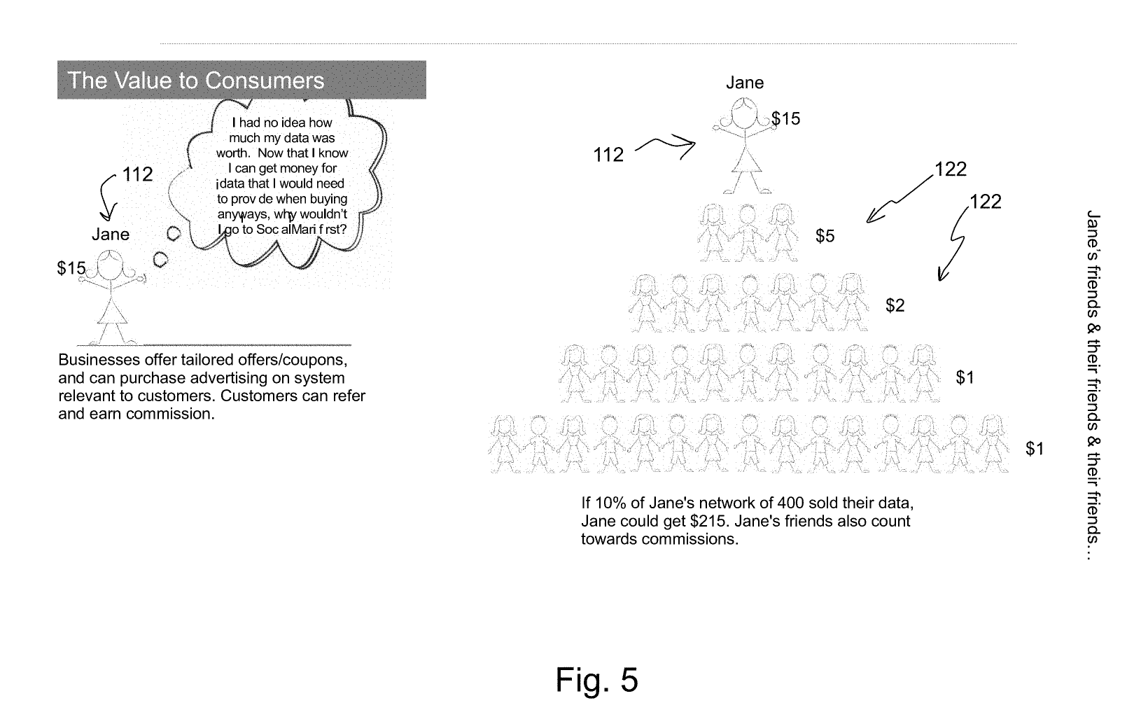

The value the system 100 provides to consumer users is illustrated in FIG. 5. Namely, in this example, the consumer 112 receives $15 for providing current and relevant information that she would have anyway when she purchases one or more of the applicable products or services. As the consumer database of the system 100 grows and iterates based on ongoing processing, algorithms, and increased user participation, businesses will be able to offer more tailored and targeted offers/coupons to consumers. The businesses can purchase advertising via the system 100 that is targeted to those in the market for their product or services, and ultimately offer discounts to consumers to buy direct. Again, a consumer can earn additional value with commissions by referring friends/family 122—for the data provided to the system 100 by these additional participants.

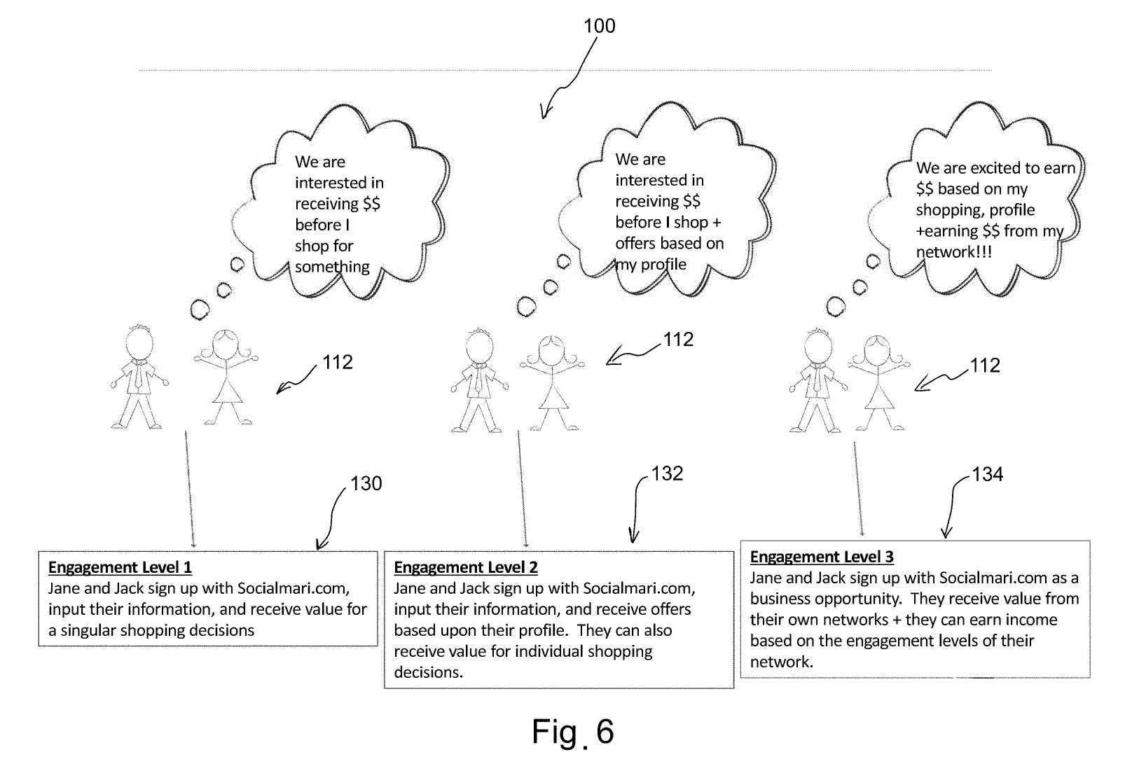

FIG. 6 demonstrates various levels of consumer engagement for embodiments of the system 100. In a first engagement level 130, consumers Jane and Jack 112 sign up or enroll with the system 100, inputting their relevant information. A particular value is received for singular shopping decisions. In a second engagement level 132, consumers Jane and Jack 112 sign up with the system 100 and receive offers based on their data profile—which can be modified, changed, and updated regularly. They also receive value for individual shopping decisions. In a third engagement level 134, consumers Jane and Jack 112 sign up and receive value from their own networks, plus income based on the engagement levels of their corresponding and interconnected network (e.g., family and friends).

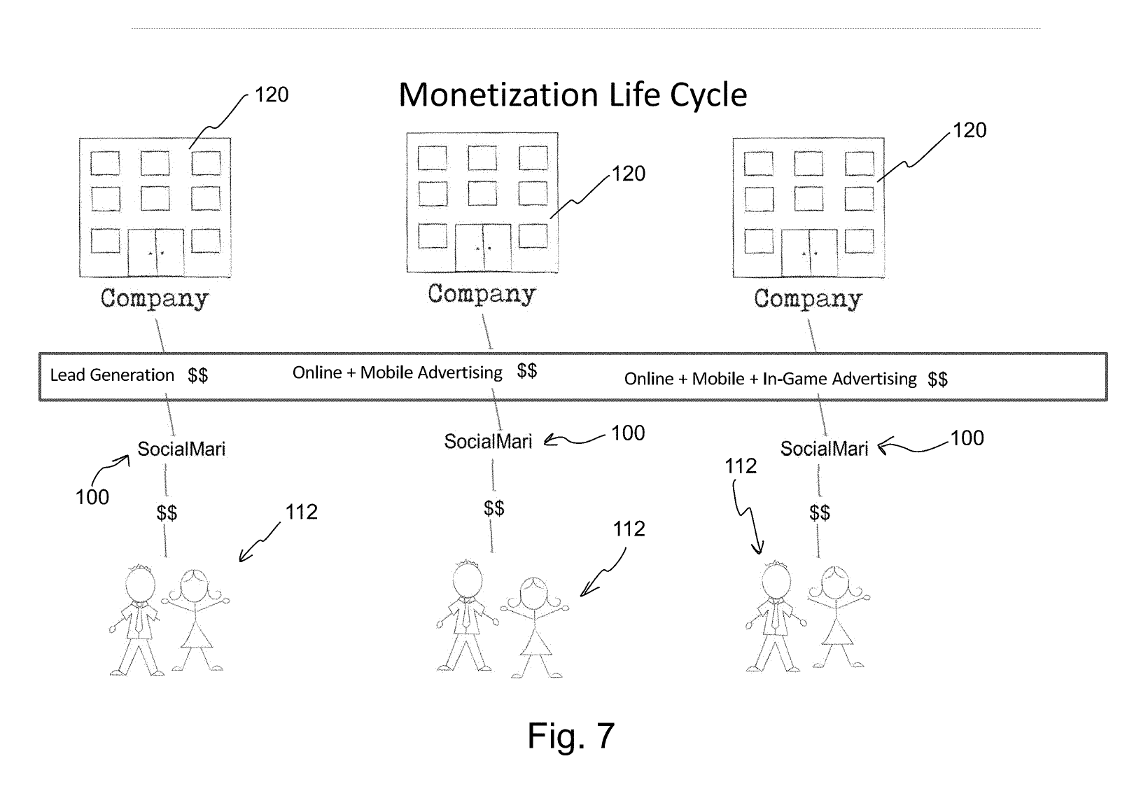

FIG. 7 illustrates exemplary monetization life cycles for the system 100, for participating consumers 112 and businesses 120 (e.g., through lead generation, online advertising, mobile advertising, in-game advertising, etc.).

Various hardware and software configurations for carrying out the disclosed methods and processes can be implemented without deviating from the spirit and scope of the present invention.

Devices or computing systems (e.g., desktop, tablet, smartphone, and the like) can be included and adapted to process and carry out the aspects, computations, and algorithmic processing of the systems 100 of the present invention. Computing systems and devices of the present invention may include a processor, which may include one or more microprocessors and/or one or more circuits, such as an application specific integrated circuit (ASIC), field-programmable gate arrays (FPGAs), etc. Further, the devices can include a network interface. The network interface is configured to enable communication with the network 105, other devices and systems, and servers, using a wired and/or wireless connection.

The devices or computing systems, e.g., devices 102, 106, may include memory, such as non-transitive memory, which may include one or more non-volatile storage devices and/or one or more volatile storage devices (e.g., random access memory (RAM)). In instances where the devices include a microprocessor, computer readable program code may be stored in a computer readable medium or memory, such as, but not limited to storage media (e.g., an SSD, a hard disk, etc.), optical media (e.g., a OVO), memory devices (e.g., random access memory, flash memory), etc. The computer program or software code can be stored on a tangible, or non-transitive, machine-readable medium or memory. In some embodiments, computer readable program code is configured such that when executed by a processor, the code causes the device to perform the steps described above and herein. In other embodiments, the device is configured to perform steps described herein without the need for code.

It will be recognized by one skilled in the art that these operations, algorithms, logic, method steps, routines, sub-routines, and modules may be implemented in software, in firmware, in special purpose digital logic, and any combination thereof without deviating from the spirit and scope of the present invention as recited within the claims attached hereto.

The computing devices 102, 104, 106 may include an input device. The input device is configured to receive an input from either a user (e.g., admin, user, etc.) or a hardware or software component—as disclosed herein in connection with the various user interface or automatic data inputs. Examples of an input device include a keyboard, mouse, microphone, touch screen and software enabling interaction with a touch screen, etc. The devices can also include an output device. Examples of output devices include monitors, televisions, mobile device screens, tablet screens, speakers, remote screens, etc. The output device can be configured to display images, media files, text, or video, or play audio to a user through speaker output.

Server processing systems 104, for use or connected with the systems 100 of the present invention, can include one or more microprocessors, and/or one or more circuits, such as an application specific integrated circuit (ASIC), field-programmable gate arrays (FPGAs), etc. A network interface can be configured to enable communication with the network 105, using a wired and/or wireless connection, including communication with devices or computing devices disclosed herein. Memory can include one or more non-volatile storage devices and/or one or more volatile storage devices (e.g., random access memory (RAM)). In instances where the server system includes a microprocessor, computer readable program code may be stored in a computer readable medium, such as, but not limited to storage media (e.g., an SSD, a hard disk, etc.), optical media (e.g., a DVD), memory devices, etc.

The present invention can be embodied as software code residing on and running from a website or server, or on a user's computing device (e.g., desktop, tablet, smartphone, and the like) and/or on the server. The various data of the present invention can be included on and transferred to and from cloud data storage 108, a storage area network (SAN), or any computing device for storing the data and files being uploaded, downloaded, or processed.

Aspects of the software code of the invention can take the form of a plugin or app, and can interface with various protocols or software using APIs or other means of interacting with computing software and systems.

While various embodiments have been described above, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

While the methods, steps, and processing described above and illustrated in the drawings are shown as a sequence of steps, this was done solely for the sake of illustration. Accordingly, it is contemplated that some steps may be added, some steps may be omitted, the order of steps may be re-arranged, and some steps may be performed in parallel.

It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products.

For purposes of interpreting the claims for the present invention, it is expressly intended that the provisions of 35 U.S.C. § 112(f) are not to be invoked unless the specific terms “means for” or “step for” are recited in a claim.

What is claimed is:

1. A social business network system, comprising:
a server including a processor, a non-transitory memory, a storage database, and a server network element;
a consumer user device including a processor, non-transitory memory, an input device, and a user network element in operative communication with the server network element;
wherein the consumer user device is adapted to receive consumer user base data at the input device and communicate at least the consumer user base data to the server; and
wherein the server processes and augments the consumer base data with additional data to determine a lead value and receive a company selection from the consumer user device such that the server processes and computes initial expectation results based on pre-defined business rules of the server.

2. The system of claim 1, wherein the consumer user base data includes at least user income data.

3. The system of claim 1, further including a cloud storage database in operative communication with at least the server for storing at least the consumer user base data and the lead value.

4. The system of claim 1, wherein the server sends customer data to one or more companies.

5. The system of claim 1, further including a business user device receiving at least the consumer base data from the server.

6. The system of claim 1, wherein the server flags a consumer user active lead status.

7. The system of claim 1, further including a business user device adapted to contact a consumer user based on information received from the server and present the consumer user with pitch media.

8. The system of claim 7, wherein the server determines whether the consumer user consumed the entire pitch media.

9. The system of claim 8, wherein if the consumer user did not consume the entire pitch media a null disposition is stored.

10. The system of claim 9, wherein the server processes whether the user has multiple null dispositions stored.
